(19) United States
(12) Patent Application Publication
(10) Pub. No.: US 2025/0250649 A1
(43) Pub. Date: Aug. 7, 2025

(54) BAINITIC WELDING AND COMPONENT

(71) Applicant: Siemens Energy Global GmbH & Co. KG, Munich, Bayern (DE)

(72) Inventors: Luk Mühlstein, Duisburg (DE); Karsten Niepold, Mülheim (DE); Torsten-Ulf Kern, Wesel (DE)

(73) Assignee: Siemens Energy Global GmbH & Co. KG, Munich, Bayern (DE)

(21) Appl. No.: 18/854,526

(22) PCT Filed: Mar. 30, 2023
(86) PCT No.: PCT/EP2023/058294

§ 371 Date: Oct. 5, 2024

(30) Foreign Application Priority Data
Apr. 13, 2022 (DE) 10 2022 203 742.1

(51) Int. Cl. C21D 1/20; B23K 9/04; B23K 9/23; B23K 31/00; B23K 103/04; B33Y 10/00; B33Y 70/00; C21D 9/50

(52) U.S. Cl. CPC C21D 1/20; B23K 9/04; B23K 9/23; B23K 31/003; C21D 9/505; B23K 2103/04; B33Y 10/00; B33Y 70/00; C21D 2211/002

(57) ABSTRACT

A method for welding a component made of steel, in which a built-up welding takes place, wherein the weld site is then allowed to cool and maintained at a holding temperature above a martensite-forming temperature for two to ten hours, or until a bainitic join has completely formed, and then it is reduced to an ambient temperature in a controlled manner, in particular, thereby concluding the heat treatment.

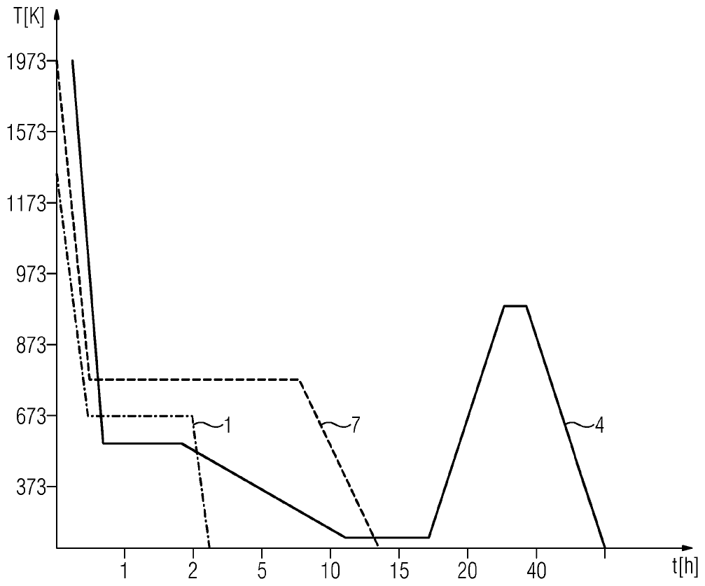

### CROSS REFERENCE TO RELATED APPLICATIONS

This application is the US National Stage of International Application No. PCT/EP2023/058294 filed 30 Mar. 2023, and claims the benefit thereof, which is incorporated by reference herein in its entirety. The International Application claims the benefit of German Application No. DE 10 2022 203 742.1 filed 13 Apr. 2022.

### FIELD OF INVENTION

The invention concerns the welding of steels in which a bainitic structure is established, and a component.

### BACKGROUND OF INVENTION

The conventional route to increasing hardness/strength in steels is that of hardening and tempering.

A second, less common route is that of austempering, known formerly as intermediate stage tempering.

In this heat treatment, the component is austenitized in the same way as in hardening—that is, depending on the material, heat treatments take place at temperatures of 1073 K-1323 K. This is followed by quenching in a molten salt bath. The temperature of the molten salt bath is governed by the material and is situated at between 533 K and 663 K. The component resides in the salt bath at constant temperature (isothermally) until the microstructure transformation from austenite to bainite (the “intermediate stage”) has concluded. NB: In this case no martensite is formed.

Depending on material, the transformation may have concluded within a few minutes. In some cases, however, it also takes several hours.

The component is subsequently cooled in the air.

This method has the advantage of optimal toughness in conjunction with continued high hardness.

Bainite microstructures have very specific properties such as high notched impact toughness (even at relatively low temperatures), improved fatigue strength, greater extension, less distortion on hardening, increased necking, better flexural characteristics.

### SUMMARY OF INVENTION

It is an object of the invention, therefore, to simplify and to shorten a thermal regime after the welding, while retaining good mechanical properties.

The object is achieved by a method as claimed and a component as claimed.

This invention comprises the transfer of the austempering to the welding, with the intention of simplifying and shortening the thermal regime after the welding, while retaining the good mechanical properties.

The dependent claims list further advantageous measures, which may be combined with one another as desired in order to achieve further advantages.

### BRIEF DESCRIPTION OF THE DRAWINGS

The figure shows three plots: the temperature profile for austempering, the temperature profile of a conventional thermal aftertreatment (tempering at T>673 K), and the temperature profile according to the invention.

### DETAILED DESCRIPTION OF INVENTION

This invention enables solutions to three different problem scenarios:

a) For large rotors of turbines, such as, in particular, of gas turbines with a power of at least 200 MW, a thermal aftertreatment (tempering or stress-relief annealing) at 873 K is not possible, since constructional circumstances, such as different thermal expansions of the materials and components, mean that the rotor might be deformed or destroyed. Additionally, safety reasons argue against the conventional method.

b) For rotors for which a thermal aftertreatment is possible, such as in the bearing-point welding of rotors, a thermal aftertreatment, while often very complicated, time-consuming and cost-intensive, is nevertheless the industry standard, since there are no other ways of achieving the internal stresses and materials properties in the zone of heat influence.

c) The quality of the targeted heat treatment of the conventional method (tempering or stress-relief annealing) is dependent on the ambient parameters and poses an elevated challenge for ensuring the respective, partly local temperatures in construction-site conditions.

Where thermal aftertreatment has been possible, welded repairs have been carried out only with the outcome of reduced mechanical materials characteristics. Additionally, the expense and consumption of time are significantly higher. If a thermal aftertreatment is not possible, a welded repair with the required materials characteristics has not been realizable.

A further solution is to machine a repair site; for safety reasons and in view of the resultant effect on other components in the system, this measure can usually be carried out only once on one and the same rotor.

It is possible to get around the problems stated hereinabove, by means of specific heat management after welding of steels, especially with ferritic microstructure and with development of bainitic microstructure.

The life of a damaged rotor can be extended. Conceivable alternative methods include the following:

### 1.) Machining the Bearing Face and Adapting the Bearings:

Adapting the bearing can be done only after the end of the machining processes and consequently takes longer than the solution described. The time taken depends on the country-specific logistics/production facilities for the bearing shells. The time delay for re-establishment of operational readiness is estimated at not less than one to two weeks. Known outage penalties are between €80 000 and €500 000 per day. Leveling of the assembly costs of the two methods (conventional and new) is assumed, as the new method requires additional welding work. For safety reasons and in view of the resultant effect on other components in the system, this method can usually be carried out only once on one and the same rotor.

### 2.) Replacing the Damaged Bearing Points Requires Activities as Follows:

The un-stacking of a gas turbine rotor, the provision and fitting of the components to be replaced, and re-stacking. Subsequently, there must then also be a final machining, to obtain the required bearing play tolerances in the stacked condition. For this period of time, fitters and machinery must be provided on site. Economically, the overall effort and expenditure corresponds to a total loss.

### 3.) Installation and Provision of a New Rotor:

This variant would not affect the time elapsing, but would entail a higher expenditure than any repair methods.

The invention employs steels which are able to form a bainitic microstructure within technically reasonable times.

These are, in particular, steels (i.e., iron with steel) with nickel (Ni), chromium (Cr), molybdenum (Mo) and vanadium (V). A particularly preferred materials class is that of 2.5-4% nickel-containing CrMoV steels, more particularly 26NiCrMoV14-5, 26NiCrMoV14-5 mod., 26NiCrMoV11-5 or 26NiCrMoV11-5 mod., very particularly, according to DIN/EN, the steels 1.6957/26NiCrMoV14-5, 1.6963/26NiCrMoV14-5 mod., 1.6948/26NiCrMoV11-5, 1.6962/26NiCrMoV11-5 mod.

In general, deposition welding is performed. For the additional material of the deposition weld, a material is used which is different from the material of the component on which the deposition welding takes place.

Different here means that at least one alloy element is present in a greater or lesser amount or that the fraction of at least one alloy element differs at least by 10%, more particularly by 20%.

Less critical is whether the material of the deposition weld is able to develop a bainitic microstructure.

In particular, the material of the deposition weld is an MnNiCrMo steel with silicon.

In this context, use is made in particular for the deposition welding of a wire which is applied under argon inert gas.

For each welding procedure, in accordance with the applicable standards, a welding procedure specification (WPS) and an annealing protocol in the case of heat treatment are mandatory. As a result, it is possible to verify whether the method to be patented here has been used.

The figure shows a number of plots of temperature-time profiles.

Plot 1 shows the temperature profile for establishing a bainitic microstructure, in which the material is heated to an austenitizing temperature of 1073 K to 1323 K, then cooled, and is held at a temperature of at least 573 K for one to two hours, with subsequent cooling, as discussed for the prior art.

With the conventional welding (plot 4), temperatures of up to 1973 K are reached, at which point the local temperature of the weld site then cools rapidly and is held at a temperature well below 573 K for one to two hours, then slowly cooled over several hours, before being heated again for several hours at a temperature greater than 773 K, with subsequent renewed cooling. This is an operation which consumes time (>40 h).

With the method of the invention according to plot 7, temperatures of up to 1973 K are likewise attained during welding, with the local temperature of the weld site then likewise cooling rapidly, but then at the temperature of greater than 573 K, or, stated generally, above the martensite formation temperature, i.e., at least 10 K above, more particularly at least 20 K above it, so that the weld site is held in particular at between 623 K and 673 K, very particularly until a bainitic microstructure has become established.

The hold time at this temperature may indeed last longer than for the first plateau in the commercial thermal aftertreatment (plot 4); in general, however, the entire thermal aftertreatment time is reduced by at least 50%, since the thermal aftertreatment has concluded after the cooling—more particularly, controlled cooling—in accordance with the invention after the plateau.

As a result of the new heat management, it is possible, with unchanged/improved materials properties, to forgo the financial expense and the time of conventional thermal aftertreatment for steels which are able to form a bainitic microstructure.

The increased cost and effort of a conventional thermal aftertreatment on site is estimated at two to three days for two to three coworkers per component.

1. A method for welding a component made of steel, comprising:
performing deposition welding at a weld site,
wherein the weld site is then left in a cooled state and is held at a hold temperature above, a martensite formation temperature for 2 to 10 hours or until complete development of a bainitic microstructure, and
wherein the hold temperature is then brought down.

2. The method as claimed in claim 1,
wherein components made of steel with nickel (Ni), chromium (Cr), molybdenum (Mo) and vanadium (V) are welded.

3. The method as claimed in claim 1,
wherein the hold temperature is at least 573 K,
but is at most 773 K.

4. The method as claimed in claim 1,
wherein material used for the deposition welding is a material which is different from the material of the component to be welded.

5. The method as claimed in claim 1,
wherein use is made for the deposition welding of a wire.

6. A component made of steel, comprising:
a deposition weld composed of steel,
wherein the component has a bainitic microstructure at least in a region of the deposition weld.

7. The component as claimed in claim 6,
wherein the component comprises a steel with nickel (Ni), chromium (Cr), molybdenum (Mo) and vanadium (V).

8. The component as claimed in claim 6,
wherein material for the deposition weld comprises a material which is different from the material of the component to be welded.

9. The method as claimed in claim 1,
wherein the component comprises a ferritic microstructure.

10. The method as claimed in claim 1,
wherein the weld site is held at a hold temperature at least 10 K above the martensite formation temperature.

11. The method as claimed in claim 1,
wherein the weld site is held at a hold temperature at least 20 K above the martensite formation temperature.

12. The method as claimed in claim 1,
wherein the temperature is brought down in a controlled manner to room temperature, and heat treatment is thereby concluded.

13. The method as claimed in claim 2,
wherein the components welded are made of a materials class of 2.5-4% NiCrMoV steels.

14. The method as claimed in claim 2,
wherein the components welded are made of steels comprising 26NiCrMoV14-5, 26NiCrMoV14-5 mod., 26NiCrMoV11-5 or 26NiCrMoV11-5 mod.

15. The method as claimed in claim 3,
wherein the hold temperature is at least 623 K to 673 K.

16. The method as claimed in claim 4,
wherein the material used for the deposition welding is an MnNiCrMo steel with silicon.

17. The method as claimed in claim 5,
wherein use is made for the deposition welding of a wire which is applied under argon as inert gas.

18. The component as claimed in claim 7,
wherein the component comprises a steel a steel of a materials class of 2.5-4% NiCrMoV steels.

19. The component as claimed in claim 7,
wherein the component comprises steels comprising 26NiCrMoV14-5, 26NiCrMoV14-5 mod., 26NiCrMoV11-5 or 26NiCrMoV11-5 mod.

20. The component as claimed in claim 8,
wherein the material for the deposition weld comprises an MnNiCrMo steel with silicon.
